(19) United States
(12) Patent Application Publication
(10) Pub. No.: US 2016/0018360 A1
(43) Pub. Date: Jan. 21, 2016

(54) MICROFLUIDIC DEVICE FOR DETECTING NUCLEIC ACIDS AND ASSOCIATED METHODS

(71) Applicants: Jun Yang, Ancaster (CA); Ponnambalam Ravi Selvaganapathy, Dundas (CA)

(72) Inventors: Jun Yang, Ancaster (CA); Ponnambalam Ravi Selvaganapathy, Dundas (CA)

(21) Appl. No.: 14/800,181

(22) Filed: Jul. 15, 2015

Related U.S. Application Data
(60) Provisional application No. 62/024,586, filed on Jul. 15, 2014.

(51) Int. Cl. G01N 27/447

(52) U.S. Cl. CPC G01N 27/44791; G01N 27/44726

(57) ABSTRACT

Described is a device that is able to distinguish different nucleic acid concentrations in whole blood or plasma sample directly in under 10 min. By using this device, cell-free DNA in whole blood or plasma can be quantified without extensive sample preparation. The device contains a sample channel, an accumulation channel and a pair of electrodes. Optionally, the device includes power supply connected to the electrodes for generating an electric field to move the DNA from the sample channel to the collection channel, and a sensor to quantify the amount of cell free DNA in the collection channel. Also provided are methods for providing a prognosis for a subject with sepsis or suspected of having sepsis comprising quantifying nucleic acid concentrations in a sample from a subject using a device as described herein.

### RELATED APPLICATIONS

This Application claims priority to U.S. Provisional Patent Application No. 62/024,586 filed Jul. 15, 2014, the contents of which are incorporated by reference herein in their entirety.

### FIELD OF THE DISCLOSURE

The disclosure relates to detecting nucleic acids in a sample and more specifically to a microfluidic device and associated methods for detecting cell free DNA in a sample.

### BACKGROUND OF THE DISCLOSURE

Cell free DNA (cfDNA) is an important biomarker in a number of conditions such as sepsis, cancer, cardiovascular disease, pre-natal diagnosis and organ transplant monitoring. For instance, sepsis can be detected from the amount of cfDNA present in blood. However, current method for quantification of cfDNA involves multiple steps including centrifugation, DNA-extraction from plasma, and its quantification either through spectroscopic methods or quantitative PCR. The whole process takes several hours and is not suitable for immediate bedside assessment.

Sepsis is a type of Systemic Inflammatory Response Syndrome (SIRS) developed from infection. It has become a leading cause of morbidity and mortality in the western world. Progression of septic condition may lead to severe sepsis in which one or more organ dysfunction, such as renal failure, is evident in addition to inflammation and infection [1]. Most patients with severe sepsis require prolonged ICU treatment, which accounts for the highest resource consumption within any hospital. Current protocols dealing with severe sepsis are mainly focused on clinical scoring systems, including the MODS and APACHE II scoring systems [2]. A major challenge with the use of these scoring systems is that the physiological parameters evaluated in the scoring systems are not specific for sepsis, thus their predictive power is poor [3]. In addition, there currently exists no routine biomarker to aid in either the diagnosis or prognosis of patients with severe sepsis, even though over 170 biomarkers had been investigated by 2010 [4]. This has been a significant factor limiting the ability to provide timely care in a condition that is resource-intensive and carries a very high mortality. Recently, circulating cell-free DNA (cfDNA) in blood has been found to be a reliable indicator for predicting mortality in ICU patients [3,5]. The study concludes that cfDNA concentration in blood is much higher in patients who died in ICU (non-survivors) compared with those who survived (survivors) based on data collected from 80 severely septic patients. The mean cfDNA levels in survivors (1.16±0.13 μg/ml) was found to be similar to that of healthy volunteers (0.93±0.76 μg/ml) (p=0.426), while that of non-survivors (4.65±0.48 μg/ml) was notably higher (p<0.001) [3]. In combination with current scoring systems (e.g. Multiple Organ Dysfunction Score, MODS) and other sepsis biomarkers (e.g. Protein C and procalcitonin), cfDNA levels can potentially have stronger predictive power [3]. Therefore, rapid quantification of cfDNA in patient blood could enable physicians to identify patients who have a lower likelihood of survival and thus, require a more aggressive care plan. It facilitates an early goal-directed therapy, which is key to saving the lives of sepsis patients. In addition, cfDNA quantification can assist ICU physicians, to utilize medical resources efficiently, thus lower the overall costs for patients and hospitals [6].

Although cfDNA quantification is a promising approach for clinical practice on severe sepsis patients in hospitals, current DNA quantification techniques (spectrophotometers and qPCR) cannot meet the requirements of the clinical applicationas they are time-consuming, and require labour-intensive sample preparation steps such as centrifugation and DNA-extraction [7, 8]. They significantly delay the prognostic results and limit the ability to provide timely care to the patients who are at high risk of death. Therefore, a point-of-care (POC) device which enables medical staff to quantify the cfDNA levels in severe sepsis patients in a real-time manner is needed.

### SUMMARY OF THE DISCLOSURE

In one aspect, there is provided a device that is able to distinguish different DNA concentrations in a sample such as whole blood or plasma. In one embodiment, the device is able to distinguish different DNA concentrations in under 10 minutes. In some embodiments, by using this device cell-free DNA in whole blood or plasma can be quantified without extensive sample preparation.

In one embodiment, the device is a microfluidic device for rapid DNA concentration and/or quantification. The microfluidic device may be used to concentrate fluorescently labelled DNA with a Direct Current (DC) electric field, and measure the fluorescent intensity which is directly proportional to the DNA concentration in the sample.

In one embodiment, the device may be used to detect cell free DNA (cfDNA) in a sample from a subject. In one embodiment, the device may be used to quantify cfDNA in a sample is from a subject having or suspected of having a disorder characterized by high blood levels of cfDNA. In one embodiment, the device may be used to identify a subject having or at risk of developing severe sepsis. In one embodiment, the magnitude of the level of cfDNA in the sample from the subject is indicative of the prognosis of the subject for developing severe sepsis. Also provided are methods for the concentration and/or quantification of cell free DNA in a sample.

In one embodiment, there is provided a microfluidic device for the quantification of nucleic acids in a sample. In one embodiment, the device comprises:

a sample channel;

an accumulation channel that forms an intersectional area with a portion of the sample channel;

a first electrode positioned within the sample channel and a second electrode positioned with the accumulation channel for applying an electric potential across the intersectional area so that when an electric potential is applied nucleic acids in the sample channel are forced into the accumulation channel across the intersectional area.

In one embodiment, the sample channel and accumulation channel are in fluid communication over the intersectional area. In one embodiment, the sample channel and the accumulation channel are made of polydimethylsiloxane (PDMS).

In one embodiment, the wherein the accumulation channel contains a medium of lower electrophoretic mobility than the sample channel. For example, in one embodiment, the accumulation channel contains a gel such as an agarose gel, optionally an agarose gel containing about 0.5%-2% agarose. In one embodiment, the accumulation channel and/or sample channel contains a fluorescent tag that binds to nucleic acid molecules, such as an intercalating agent, optionally ethidium bromide or PicoGreen.

In one embodiment the microfluidic device described herein includes a power supply for providing an electric potential to the first electrode and second electrode, optionally a DC power supply or an AC power supply. In one embodiment, the electric potential is between about 1 volt and 20 volts, less than 15 volts, less than 12 volts or less than 10 volts.

In one embodiment, the microfluidic device described herein includes a sensor for detecting nucleic acid molecules at the intersectional area. In one embodiment, the sensor is for detecting fluorescence in the intersectional area. Optionally, the sensor comprises a light source for providing an excitation wavelength and a light sensor for detecting fluorescent emissions. In one embodiment, the sensor comprises a fluorescent microscope.

In another aspect, there is provided a method for quantifying cell free DNA (cfDNA) in a sample. In one embodiment, the method comprises:

introducing the sample into the sample channel of a microfluidic device as described herein;

applying an electric potential across the intersectional area; and

detecting a level of fluorescence in the intersectional area, wherein the level of fluorescence in the intersectional area is indicative of the amount of cfDNA in the sample.

In one embodiment, the sample is contacted with a fluorescent tag that binds to nucleic acids prior to introducing the sample into the sample channel. In one embodiment, the accumulation channel comprises an electrophoretic medium that comprises a fluorescent tag that binds to nucleic acids.

In one embodiment, the sample is blood or blood plasma. In one embodiment, the sample has not been treated or modified prior to being introduced into the sample channel.

In one embodiment, the sample is from a subject having or suspected of having a disorder characterized by high blood levels of cfDNA, such as severe sepsis, cancer, cardiovascular disease. In one embodiment, the methods and devices described herein are for the concentration and/or quantification of nucleic acids for pre-natal diagnosis.

In one embodiment, the method further comprises comparing the level of fluorescence in the intersectional area to a control level. For example, in one embodiment, the control level is representative of the level of cfDNA in blood or plasma of subjects with or without a disorder characterized by high levels of cfDNA in blood and a difference or similarity between the level of fluorescence in the intersectional area and the control level is indicative of the subject having or not having a disorder characterized by high levels of cfDNA in blood. In one embodiment, the disorder characterized by high levels of cfDNA in blood is severe sepsis. In one embodiment, the level of the cfDNA in the sample from the subject is indicative of the prognosis of the subject for developing severe sepsis and/or dying.

Also provided are methods for concentrating and quantifying cell free DNA (cfDNA) in a sample. In one embodiment, the method comprises:

introducing the sample into a sample channel;

applying an electric potential across an intersectional area separating the sample channel from an accumulation channel to generate an electrophoretic force acting on the cfDNA in the sample channel so that the cfDNA in the sample channel is attracted to the intersectional area; and

detecting cfDNA in the intersectional area.

In one embodiment, the sample is contacted a fluorescent tag that binds to nucleic acids. In one embodiment, detecting cfDNA in the intersectional area comprises detecting a level of fluorescence in the intersectional area. In one embodiment, the level of fluorescence in the intersectional area is indicative of the amount of cfDNA in the sample. In one embodiment, the method is useful for identifying a subject having, or at risk of developing, severe sepsis. In one embodiment, the methods described herein are useful for providing a prognosis for a subject having or suspected of having sepsis, wherein the magnitude of the level of cfDNA in the sample from the subject is indicative of the severity of sepsis in the subject.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

One or more embodiments of the disclosure will now be described in relation to the drawings in which:

FIG. 1 shows a diagram of one embodiment of the device.

FIG. 2 shows one embodiment of the device and how the gel is exposed to the sample channel at the intersectional area with the accumulation channel.

FIG. 3 shows the working principle of one embodiment of the device wherein the application of an electric field results in a cell free DNA migrating into the accumulation channel and the generation of a fluorescent signal.

FIG. 4 shows a schematic of one embodiment of the device and experimental configuration: the sample channel (top) intersects with the accumulation channel (bottom). A DC power supply is connected between the sample outlet and the gel inlet. The accumulation channel is filled with 1% agarose gel (red), and sample fluid is loaded in the sample channel.

FIG. 5 shows results from an experiment demonstrating DNA accumulation. The curve shows the timely change of fluorescent intensity at the intersection with no voltage applied (blue) and with 9V applied (red). The fluorescent images at time points of 0, 5, and 10 min were shown. Dash lines represent the outlines of the sample channel and the accumulation channel; error bars represent standard deviation (SD).

FIGS. 6A, 6B and 6C show the results from numerical simulations: FIG. 6A the electric field intensity at a cross-sectional plane at the intersection; FIG. 6B the electric field contours at the intersection. The difference between each line is fixed as 0.5 mV/μm, thus the denser the contours are, the higher the electric field gradient; FIG. 6C directions of EP force (red arrows) and DEP force (black arrows) in a plane 1 μm above the bottom of sample channel. The yellow area represents the intersection region.

FIGS. 7A and 7B show a comparison of the simulation and the experimental results: FIG. 7A the simulated electric field distribution on the bottom plane of the sample channel. The colour band demonstrates the intensity of electric field, which reaches the maximum at the intersection edge; FIG. 7B the DNA accumulation result using the 1 μg/ml DNA spiked plasma sample. The dash lines are the edge of the sample channel and the accumulation channel.

FIG. 8 shows fluorescent intensity values at the beginning (0 min) and the end (5 min) of DNA accumulation with 3 different voltages applied. Error bars represent SD.

FIGS. 9A, 9B and 9C show experimental results using DNA in buffer sample: error bars represent SD. 9V was applied; FIG. 9A fluorescent images taken at time intervals of 0, 1, 2, 3 and 4 min demonstrating the DNA accumulation process at the intersection with 1 μg/ml and 5 μg/ml DNA concentration; FIG. 9B fluorescent intensity curves during DNA accumulation; FIG. 9C fluorescent intensity values at the beginning (0 min) and the end (4 min) of DNA accumulation.

FIGS. 10A, 10B and 10C show experimental results using DNA spiked plasma sample: error bars represent SD. 9V was applied; FIG. 10A fluorescent images taken at time intervals of 0, 1, 2, 3 and 4 min demonstrating the DNA accumulation process at the intersection with 0.8 μg/ml and 4.2 μg/ml DNA concentration; FIG. 10B fluorescent intensity curves during DNA accumulation; FIG. 10C fluorescent intensity values at the beginning (0 min) and the end (4 min) of DNA accumulation.

FIGS. 11A and 11B show experimental results using the clinical plasma sample: error bars represent SD. 9V was applied; FIG. 11A fluorescent intensity at the beginning (0 min) and the end (5 min) of DNA accumulation; FIG. 11B fluorescent intensity of the healthy sample and 6 μg/ml patient sample.

FIG. 12 shows fluorescent intensity at the beginning (0 min) and the end (5 min) of DNA accumulation using DNA spiked whole blood sample: error bars represent SD. 9V was applied. The concentration of 0 μg/ml represents whole blood with no extraneous DNA added.

FIG. 13 shows fluorescent images taken at time intervals of 0, 1, 3, and 5 min with PicoGreen integrated device (with PicoGreen) and regular device (without PicoGreen); 9V was applied. The sample was 5 μg/ml DNA spiked plasma with no PicoGreen pre-mixed.

FIG. 14 shows a microfluidic device according to one embodiment of the description.

### DETAILED DESCRIPTION

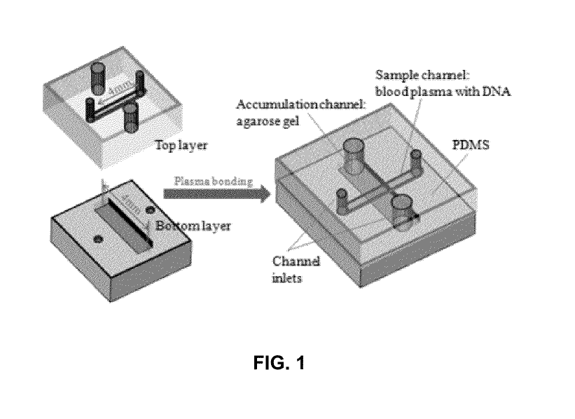

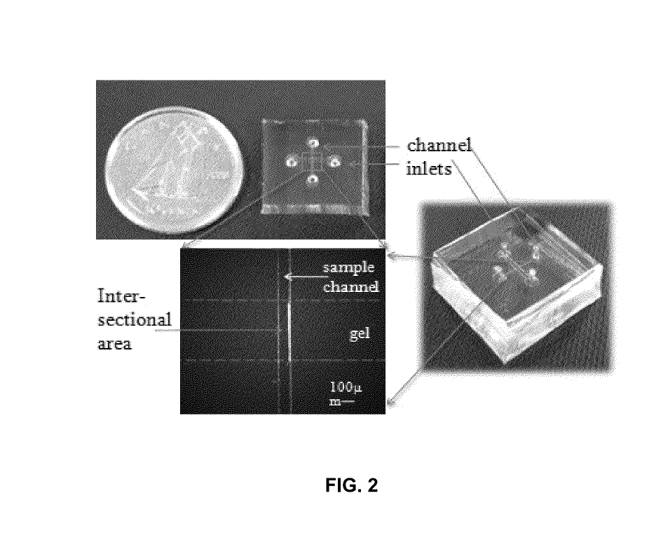

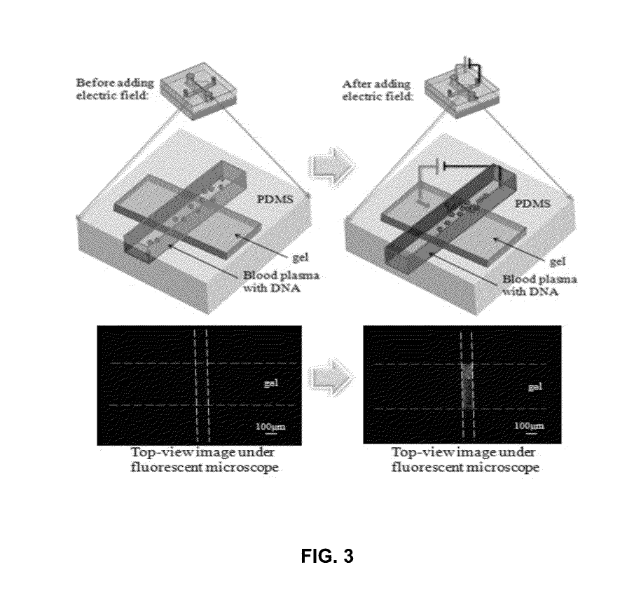

One embodiment of a microfluidic device of the present description is shown in FIG. 1. The device comprises of two polydimethylsiloxane (PDMS) channels: a sample channel (top) and an accumulation channel (bottom) that intersect each other. The accumulation channel is preloaded with 1% agarose gel such that the gel is exposed to the sample channel at the intersectional area shown in FIG. 2. The working principle of the device is shown in FIG. 3. Since the DNA is negatively charged, it can be transported electrophoretically in free solution and in a gel. Application of a DC electric field with the positive electrode in the gel will drive the DNA present in the sample into the gel while not affecting neutral species. The positively charged species is driven in the other direction. AC fields can also be used for this purpose. For instance, the use of asymmetrical AC or symmetrical but long time period AC electric fields can drive the DNA into the gel in the positive half of the cycle and entangle it in the gel during the field reversal in the negative half of the cycle. The amount of DNA present is representative of the local concentration of DNA in the immediate vicinity of the gel region. Since this method extracts only the DNA from a complex matrix, it could potentially be used in a variety of situations to extract DNA from whole blood or from plasma without extensive sample preparation.

The quantification of the DNA may be done using fluorescence (FIG. 3). FIG. 3 shows the comparison of the intersection region between the two channels and demonstrate that the application of electric field leads to accumulation of DNA. The fluorescence intercalating tag can be added to the sample prior to its injection into the device. Alternatively, it could be immobilized in the sample channel to be mixed with the sample when it is added to the device. It can also be placed in the gel such that when the DNA enters the gel the tag could intercalate with the DNA. The accumulation of the DNA shows as increase in fluorescence and therefore can be measured by a camera or a photodetector with appropriate filters. Various types of intercalating tags that bind to nucleic acids such as, but not limited to, ethidium bromide and Picogreen may be used in the microfluidic device described herein.

In one embodiment, the microfluidic device described herein is useful for quantification of DNA for the diagnosis and/or prognosis of sepsis. Cell-free DNA(cfDNA) in blood samples has been shown to have a high discriminative power to predict ICU mortality in patients with severe sepsis, which is of great help for clinical decision making by doctors. A cell-free DNA concentration gap exists between the blood sample of survivors and that of nonsurvivors. Based on the statistic analyses on 80 severe sepsis patients, the mean cfDNA levels in survivors (1.16±0.13 μg/ml; n=46) was similar to that in healthy volunteers (0.93±0.76 μg/ml; n=14), while the mean levels of cfDNA in nonsurvivors (4.65±0.48 μg/ml; n=34) was markedly higher compared with survivors.

The inventors have demonstrated that the increasing rates of fluorescent intensity were varied based on different concentrations of DNA in the sample channel. For 1 μg/ml cfDNA in plasma, around 20% increase of fluorescent intensity was yielded during 4 minutes of accumulation time, while over 100% fluorescent increase was reached when using plasma containing 5 μg/ml cfDNA with the same experimental setup. The inventors also demonstrated that the technology works with whole blood, further simplifying the whole detection process.

In one aspect of the disclosure, the microfluidic device can be developed into a point-of-care device which is a non-invasive, rapid and low-cost tool for clinical diagnosis and monitoring of some diseases. A number of recent studies indicate that increased levels of cell-free DNA in blood plasma were found in some clinical disorders such as cancers, trauma, and stroke etc. For example, a study showed 10 times higher plasma DNA concentrations in myocardial infraction (MI) patients than controls. By using this device, the concentration of circulating DNA in the whole blood/plasma sample can be measured rapidly allowing for the identification of subjects at having or at risk of developing disorders associated with high levels of cfDNA.

The microfluidic device described herein and associated methods offer a number of advantages for the detection of nucleic acids such as DNA. Advantages and features of some embodiments of the microfluidic device and methods described herein, include:
Simple sample preparation: This method eliminates several sample preparation steps such as centrifugation, DNA extraction and amplification in quantifying cfDNA.
Works directly on the sample matrix: The device can process raw sample without extensive preparation.
Rapid: The entire quantification can be performed within 5-10 min.
Low cost. As a disposable device, the material is mainly PDMS and agarose gel, both of which have very low cost. With current design, the cost for each device can be down to around 50 cents. The other parts of the measuring setup like electrodes can be repeatedly used, thus the cost is also kept low.
Low sample consumption. With the current size of the sample channel, the volume of the sample fluid needed in one test is way less than 1 μL, which is a very tiny droplet volume. In one embodiment, the device is useful for detecting cfDNA levels using a single blood droplet. With just one slight poke to the skin, a measurement of the circulating DNA concentration can be completed. The low sample consumption benefit of this device makes the use of small sample volumes possible.
Potential to be portable. As mentioned before, the size of the device can be as small as a dime, making it possible to be developed into a portable and compact point-of-care device. Because of the low voltage requirement (lower than 10V), batteries can be used to replace a DC power supply; Also instead of using a fluorescent microscope, a cheaper and highly compact system (for example, a LED light source, a band-pass filter, and a photo detector system) can be integrated with the device.

The inventors have tested the device with a mixture of DNA and plasma from healthy donors (to simulate the sample from real patients) as well as using clinical samples.

As shown in the Examples, the inventors have developed a low-cost microfluidic device capable of rapid quantification of cfDNA in a small droplet (<10 μl) of blood plasma or whole blood in 5 minutes using only electrical power. The cfDNA in samples is selectively labeled by an fluorescent tag intercalating agent (PicoGreen), and is extracted and concentrated by electrophoresis into a gel by application of a DC potential of 9V. This device can be used as a diagnostic and/or prognostic tool for early assessment of mortality and monitoring of therapy efficacy for subjects having or suspected of having a disorder associated with high levels of cfDNA in blood, such as sepsis.

As used herein, the term “sepsis” refers to a whole-body inflammatory response to an infection. Severe sepsis is sepsis with sepsis-induced organ dysfunction or tissue hypoperfusion (manifesting as hypotension, elevated lactate, or decreased urine output). In some embodiments, severe sepsis may lead to septic shock and/or death.

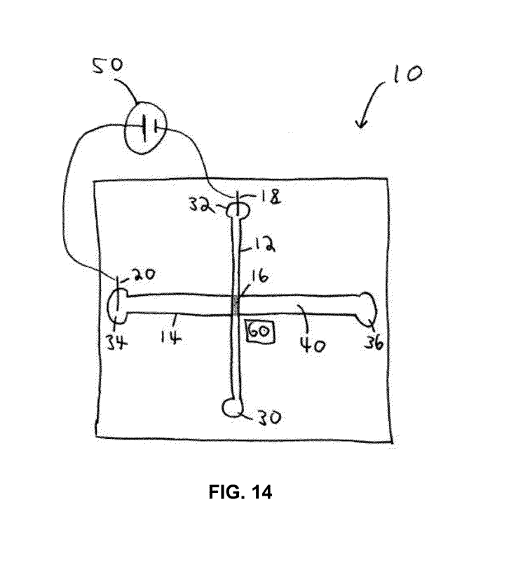

Turning to FIG. 14, there is provided a microfluidic device (10) for the quantification of nucleic acids in a sample, the device comprising:

a sample channel (12);

an accumulation channel (14) that forms an intersectional area (16) with a portion of the sample channel;

a first electrode (18) positioned within the sample channel (12) and a second electrode (20) positioned with the accumulation channel (14) for applying an electric potential across the intersectional area (16) so that when an electric potential is applied nucleic acids in the sample channel (12) are forced into the accumulation channel (14) across the intersectional (16) area.

In one embodiment, the sample channel (12) and accumulation channel (14) are in fluid communication over the intersectional area (16). Optionally, the microfluidic device comprises two layers and the sample channel (12) is in a first layer and the accumulation channel (14) is in a second layer below the first layer.

As shown in FIG. 14, the sample channel (14) and the accumulation channel (14) may be positioned such as to be perpendicular in the microfluidic device (10). Optionally, other arrangements of the sample channel (14) and the accumulation channel (14) may be used that define an intersectional area (16) may also be used.

The microfluidic device (10) may be made of a suitable material such as polymeric organosilicon compounds, glass, polystyrene, polycarbonate, epoxy, cyclic olefin polymer or acrylic. For example, in one embodiment the sample channel (12) and the accumulation channel (14) are made of polydimethylsiloxane (PDMS). In one embodiment, at least part of the microfluidic device (10) is made of optically clear material to allow for the detection of fluorescence at the intersectional area (16).

In one embodiment, the sample channel (12) comprises a sample inlet (30) and a sample outlet (32) and the intersectional area (16) is positioned between the sample inlet (30) and the sample outlet (32).

In one embodiment, the accumulation channel (14) comprises an accumulation channel inlet (34) and an accumulation sample outlet (36) and the intersectional area (16) is positioned between the accumulation channel inlet (34) and the accumulation channel outlet (36).

In one embodiment, the accumulation channel (14) contains a medium of lower electrophoretic mobility (40) than the sample channel (12). In one embodiment, the medium of lower electrophoretic mobility (40) is a gel, such as an agarose gel, polyacrylamide gel, other hydrogels or an ionic liquid gel. In one embodiment, the gel is an agarose gel comprising between about 0.5% and 2% agarose.

In one embodiment, the sample is contacted with a fluorescent tag that binds to nucleic acids prior to, or after, being introduced into the sample channel (12). In one embodiment, the fluorescent tag is an intercalating agent. Examples of fluorescent tag intercalating agents include, but are not limited to, ethidium bromide, PicoGreen, SYBR Green I, Syto-13 and Syto-82

In one embodiment, the fluorescent tag is introduced into the sample., channel (12) prior to, or after, the sample is introduced into the sample channel (12). In one embodiment, the fluorescent tag is present in the medium of lower electrophoretic mobility (40), such as mixed in with a gel that is introduced into the accumulation channel (12).

In one embodiment, the sample channel (12) has a length of about 0.4 to 40 mm, a width of about 10 μm to about 1000 μm and/or a depth of about 6 μm to about 600 μm. In one embodiment, the sample channel (12) has a length of about 2-6 mm, a width of about 50-150 μm and a depth of about 60 to 90 μm. In one embodiment, the accumulation channel has a length of about 2-6 mm, a width of about 250 μm to about 750 μm and a depth of about 80 μm to about 320 μm. Optionally, the sample channel (12) and/or accumulation channel (14) have a square or rectangular cross section. In one embodiment, the sample channel (12) and/or accumulation channel (14) have an elliptical or circular cross section.

In one embodiment, the microfluidic device (10) further comprises a power supply (50) for providing an electric potential to the first electrode (18) and second electrode (20). The power supply may be a direct current (DC) power supply or an alternating current (AC) power supply. In one embodiment, the power supply provides an electric potential of between about 1 volt and 20 volts, between about 3 volts and 15 volts, between about 6 volts and 12 volts, between about 8 and 10 volts, or about 9 volts. A skilled person will readily be able to select an appropriate electric potential for a particular microfluidic device as described herein based factors such as the particular dimensions of the microfluidic device, the characteristics of the sample to be analyzed and the medium in the accumulation channel.

In a preferred embodiment, the sample comprises cell free DNA (cfDNA) and the microfluidic device and methods described herein are for concentrating and/or quantifying cfDNA from a sample. As used herein “cell free DNA”, otherwise known as circulating cell free DNA, refers to nucleic acid molecules such as RNA and/or DNA, that are no longer contained in cells and are detectable in the bloodstream.

In one embodiment, the sample comprises blood cells and when an electric potential is applied the blood cells are forced away from the intersectional area in the sample channel by a dieletrophoretic force. As set out in the Examples, this facilitates the concentration and detection of cfDNA at the intersectional area.

In one embodiment, the microfluidic device (10) further comprises a sensor (60) for detecting nucleic acid molecules at the intersectional area (16). In one embodiment, the sensor (60) is for detecting fluorescence in the intersectional area. In one embodiment, the sensor (60) comprises a light source for providing an excitation wavelength to the intersectional area (16) and an optical sensor for detecting one or more emission wavelengths from the intersectional area.

In another embodiment, there is provided a method for quantifying cell free DNA (cfDNA) in a sample. In one embodiment, the method comprises:

introducing the sample into the sample channel of a microfluidic device as described herein;

applying an electric potential across the intersectional area; and

detecting a level of fluorescence in the intersectional area,

wherein the level of fluorescence in the intersectional area is indicative of the amount of cfDNA in the sample.

In one embodiment, the sample is contacted with a fluorescent tag, such as an intercalating agent, that binds to nucleic acids prior to introducing the sample into the sample channel. In one embodiment, the accumulation channel comprises an electrophoretic medium that comprises a fluorescent tag that binds to nucleic acids.

In one embodiment, applying an electric potential across the intersectional area comprises applying a voltage of between about 1 volt and 20 volts, between about 3 volts and 15 volts, between about 6 volts and 12 volts, between about 8 and 10 volts, or about 9 volts. In one embodiment, the electric current is AC. In one embodiment, the electric current is DC.

In one embodiment, the electric potential is applied across the intersectional area for a time period sufficient to concentrate and detect cfDNA at the intersectional area. For example in one embodiment, electric potential is applied across the intersectional area for between about 30 seconds and 10 minutes, between about 1 minute and 5 minutes, less than 10 minutes, less than 8 minutes, less than 6 minutes, less than 5 minutes or less than 4 minutes.

In one embodiment, the sample is from a subject, such as a member of the animal kingdom. In one embodiment, the sample is from a mammal such as a human. In one embodiment, the sample is from a subject having or suspected of having a disorder characterized by high blood levels of cfDNA. cfDNA and its association with various disorders has been described generally by Van der Vaart and Pretorius [29]. cfDNA has been identified as a biomarker in cancer patients [30]. Accordingly, in one embodiment the microfluidic device and methods described herein may be used to identify and/or provide a prognosis for subjects with cancer. cfDNA has been identified as a biomarker for myocardial infarction [31]. Accordingly, in one embodiment the microfluidic device and methods described herein may be used to identify and/or provide a prognosis for subjects with myocardial infarction. cfDNA has been identified as a biomarker for sepsis [32]. Accordingly, in one embodiment the microfluidic device and methods described herein may be used to identify and/or provide a prognosis for subjects with sepsis or severe sepsis. cfDNA has been identified as a biomarker for inflammation [33]. Accordingly, in one embodiment the microfluidic device and methods described herein may be used to identify and/or provide a prognosis for subjects with inflammation,

In one embodiment, the sample is blood or blood plasma or other sample in which cfDNA is detectable. Optionally, the sample is not modified to remove contaminants or material other than cfDNA prior to introducing the sample into the sample channel.

In one embodiment, the methods described herein include comparing the level of fluorescence in the intersectional area to a control level. Optionally, the methods described herein include comparing the level of cfDNA determined by using a methods and/or device described herein, to a control level. In one embodiment, the control level is representative of subjects with a disorder characterized by high blood levels of cfDNA whose clinical outcome is known.

For example, in one embodiment, the sample is from a subject having or suspected of having severe sepsis, the control level is representative of subjects with severe sepsis and a similarity between the level of fluorescence in the intersectional area of the sample from the subject and the control level is indicative of the subject having or developing severe sepsis.

In one embodiment, the control level representative of subjects having or developing severe sepsis corresponds to a blood cfDNA level of greater than greater than 3.5 μg/ml, greater than 4.0 μg/ml or greater than 4.5 μg/ml.

In one embodiment, the sample is from a subject having or suspected of having severe sepsis, the control level is representative of subjects without severe sepsis and an increase in the level of fluorescence in the intersectional area of the sample from the subject relative to the control level is indicative of the subject having or developing severe sepsis.

In one embodiment, the control level representative of subjects without severe sepsis corresponds to a blood cfDNA level of less than 3.0 μg/ml, less than 2.5 μg/ml, less than 2.0 μg/ml or less than 1.5 μg/ml.

In another embodiment, there is provided a method for concentrating and quantifying cell free DNA (cfDNA) in a sample. In one embodiment, the method comprises:
introducing the sample into a sample channel;
applying an electric potential across an intersectional area separating the sample channel from an accumulation channel to generate an electrophoretic force acting on the cfDNA in the sample channel so that the cfDNA in the sample channel is attracted to the intersectional area; and
detecting cfDNA in the intersectional area.

In one embodiment, the sample is contacted with a fluorescent tag that binds to nucleic acids prior to, or after, the sample is introduced into the sample channel. In one embodiment, detecting cfDNA in the intersectional area comprises detecting a level of fluorescence in the intersectional area, wherein the level of fluorescence in the intersectional area is indicative of the amount of cfDNA in the sample. Optionally, the method comprises use of the microfluidic device as described herein. In one embodiment, the method comprises comparing a level of cfDNA determined for a sample from a subject to a control level as described herein. Optionally, the method is for identifying or providing a prognosis for a subject having or suspected of having a disorder characterized by an increase in cfDNA in the blood such as sepsis.

The following non-limiting examples are illustrative of the present disclosure:

### EXAMPLES

The basic goal of the device is to: 1) quickly differentiate between survivors (˜1 μg/ml) and non-survivors (over ˜5 μg/ml) in severe sepsis patients based on cfDNA concentration in blood, and 2) measure the various cfDNA levels in those non-survivors. To realize this objective, several operations may be performed: 1) cfDNA in blood should be separated from the constituents that may significantly influence quantification results, such as red blood cells; 2) cfDNA should be concentrated for better quantification due to its low concentration in blood; 3) the concentration value needs to be transduced into an optical or an electrical signal which can be easily recorded and quantified. Based on these requirements, an electrokinetic (EK) approach [9-15] was selected to extract and concentrate cfDNA in blood as it is a reagent-free process and relatively fast compared with other DNA extraction methods such as silica-based absorptive extraction [16-18], pH-induced DNA capture [19, 20], aluminium oxide membrane filtration [21], and DNA binding with functionalized microparticles [22, 23]. In the EK process, a DC voltage is applied to continuously transport the DNA present in the sample on to a gel, where its mobility is lower, in order to accumulate it over a certain period of time. A fluorescent intercalating tag attached to the DNA is used to quantify the amount of accumulated cfDNA and transduce the signal into the electrical domain. The combination of selective fluorescent staining of all the cfDNA in blood and its electrophoretic accumulation on the gel make it suitable to quantify cfDNA in a short period of time.

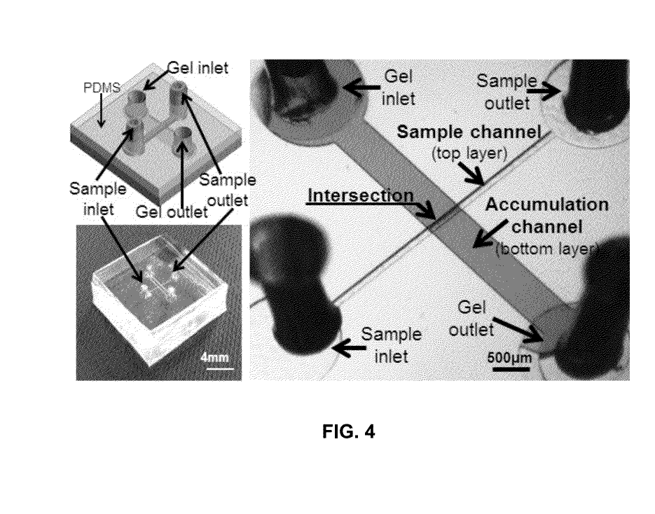

A microfluidic device designed for this purpose consists of two PDMS layers that intersect each other as shown in FIG. 4. The top layer contains a sample channel with a dimension of 4 mm (L)×100 μm (W)×60 μm (D). The bottom layer contains an accumulation channel with a dimension of 4 mm (L)×500 μm (W)×160 μm (D). The two channels are positioned perpendicular to each other, and meet at an intersection where the two channels are fluidically connected. The accumulation channel is pre-filled with 1% agarose gel, while the sample liquid is loaded in the sample channel. Two electrodes are placed in the gel inlet (anode), and at the sample outlet (cathode) as depicted in FIG. 4. When a potential is applied, the DNA from the sample in the sample channel gets selectively transported to the intersection of that channel and the gel in the accumulation channel and gets concentrated at that location.

The contents of the blood sample are influenced by 3 main electrokinetic forces in a spatially non-uniform DC electric field such as the one in this geometry, namely: the electrophoretic (EP) force, the dielectrophoretic (DEP) force and the electroosmotic (EO) force.

EP force is the net Coulomb force a charged particle and its electric double layer (EDL) ions experienced in the electric field. A negatively charged particle in the sample channel, typically a DNA molecule, will move towards the anode under the EP force. In this device, DNA moves into the gel at the intersection.

Contents in blood also experience DEP forces due to a polarization process in the non-uniform electric field. Most of them, including DNA and blood cells, are subjected to a negative DEP force, which is directed to a local electric field minimum. In the sample channel, particles will move away from the intersection due to the higher electric field there. The DEP force is proportional to the particle volume and the gradient of the electric field squared. The magnitude of force reduces dramatically with the scaling down of the particle size as compared to other forces that are dependent on size. Therefore, the DEP force is usually ignored on small biomolecules such as DNA, while it can be a dominating force for blood cells.

In the sample channel, an EO flow of around 200 μm/sis estimated to be generated due to the EDL formed at the surface of the PDMS [24]. The EO force refers to the drag force acting on the particles because of the EO flow. However, in the plasma or blood sample, the EO flow can be significantly reduced by the absorption and interaction between the proteins or cells and the channel surface [25]. As a result, the actual electroosmotic flow will be very small and is ignored for the DNA motion analysis.

According to the analysis above, the transport of cfDNA in the blood sample should be dominated by EP force which drives it into the gel at the intersection. However, the DEP force may have a significant influence on the blood cells, and move them away from the gel at the intersection. As a result, an electric field established at this intersection between a channel and gel can potentially be used to separate cfDNA from other constituents of the blood sample.

### Experimental Materials and Methods

### Experimental Setup

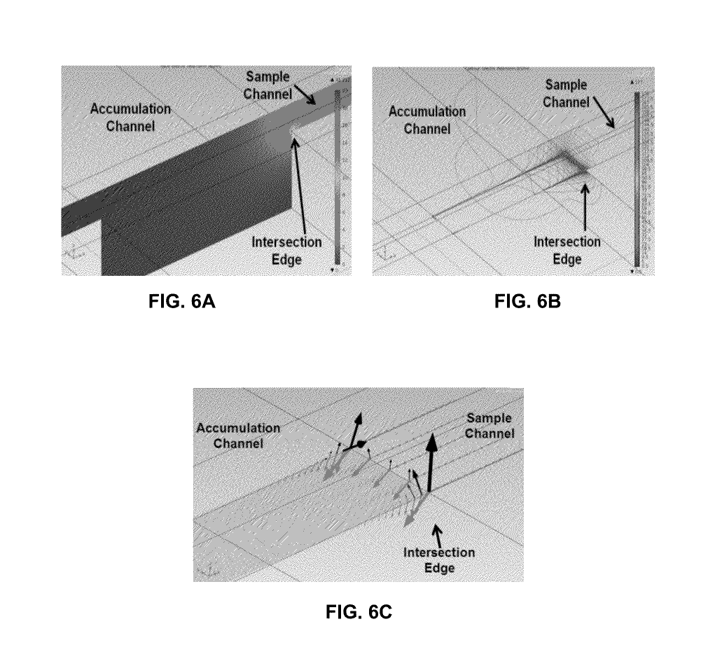

The device was placed on a fluorescent microscope (Model 500 Lumascope) with a 10× lens. A droplet of heated 1% agarose gel (BioShop) was dropped at the gel inlet of the accumulation channel. Then an empty syringe was used to aspirate the gel solution from the gel outlet. During the aspiration, liquid gel solution fills the accumulation channel completely, while the sample channel stays clear due to aspiration of air from it. Once the gel solution cooled down and gelled (˜20 seconds), the sample solution was injected into the sample channel using a clean 1ml syringe (BD Luer-Lok™Tip) connecting with a 20G needle (BD PrecisionGlide™). Silver wires (0.2 mm diameter, Warner Instruments) were inserted into the gel inlet and sample outlet as electrodes, and were connected with a DC power supply (Keithley 2410). The accumulation channel was connected with anode, while the sample channel was connected with cathode. During experiments, a positive DC voltage was applied, and the device was covered with a black cloth in order to reduce background light interference from outside. The fluorescent microscope was connected with a laptop, through which the DNA accumulation process can be observed and recorded (FIG. 6(b)).The brightness of the light source (LED) in the microscope was set as 29 using the software, which represented an illuminance of around 1.0×10⁴ lux, measured with a digital lux meter (LX1332B, Vicimeter Technology CO., LTD.). Brightness was maintained the same throughout all the experiments.

### Experimental Method

Quant-iT™PicoGreen® dsDNA Reagent and Kits (Life Technologies) were used to prepare fluorescently labelled DNA samples. PicoGreen is a very sensitive stain for DNA quantification, even with the presence of most contaminants. Clinical samples, including whole blood and blood plasma of healthy donors and patients, were received from a collaborative project, DNA as Prognostic Marker in ICU Patients Study. The study was approved by the Research Ethics Board of McMaster University and Hamilton Health Sciences, Hamilton (REB approval 10-532). In each experiment, the prepared sample liquid was stored in a testing tube which was wrapped with aluminium foil, and was left in room temperature for 10 minutes to make sure DNA and PicoGreen were thoroughly intercalated.

During each experiment, fluorescent images were collected at specific time points (0, 30 s, 1 min, 2 min, 3 min, 4 min, and 5 min) to monitor the change of the fluorescence at the intersection, while minimizing the errors introduced by photobleaching of the dye. The collected fluorescent pictures were processed using ImageJ (1.48 v) to characterize the fluorescent intensity. The original RGB pictures were transferred into 8-digit grey scale format which has a value range of 0-255. The brighter the fluorescence was, the higher the grey scale value was for each pixel. A mean grey scale value was calculated at a pre-selected area enclosing the intersection edge. After subtracting the fluorescent intensity value of the sample channel background, the new value was used as a parameter representing the fluorescent intensity of the accumulated DNA.

### Experimental Results and Discussion

### Demonstration of DNA Accumulation

In order to demonstrate that DNA can be efficiently accumulated on the gel at the intersection region, a proof of concept experiment was performed. A 1 μg/ml DNA spiked plasma sample was used in this experiment. It was prepared as follows: 1) the original λ-DNA solution in the kit was diluted to 20 μg/ml using TE buffer. This concentration was confirmed using a spectrophotometer (NanoDrop 2000); 2) it was added to the blood plasma from a healthy donor to achieve a final concentration of 4 μg/ml; 3) this sample was mixed with 200-fold diluted PicoGreen reagent in a 1:3 volume ratio. During the experiment, no voltage was applied for the first 5 minutes after sample loading, while 9V was applied for the next 5 minutes.

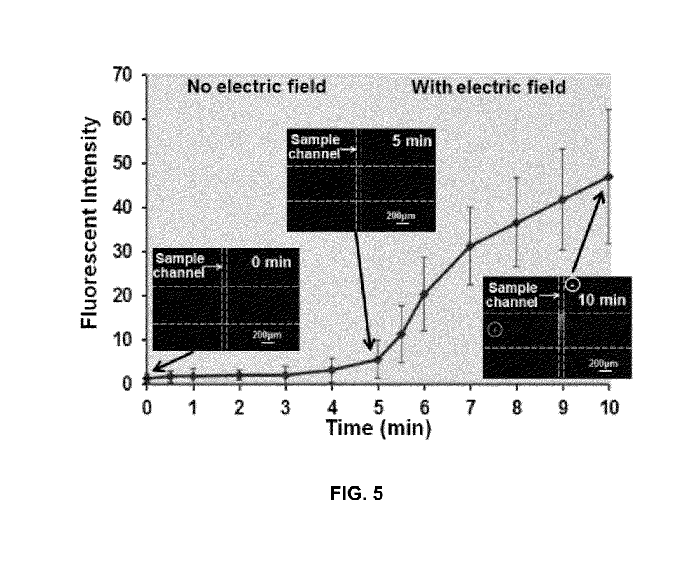

FIG. 5 shows the change of fluorescent intensity at the intersection obtained over the duration of the experiment. When no voltage was applied (blue area), no increase in fluorescence intensity can be observed (p=0.2281, α=0.01 between 0 min and 5 min). But after applying 9V (red area), a rapid increase of the fluorescent intensity can be observed from 5 min to 7 min, followed by a slower and more linear increase from 7 min to 10 min.

DNA at the intersection was immediately transported to the gel by EP force upon the application of the electric field, which led to a rapid increase during the first minute. After the initial accumulation, the region close to the gel is depleted of the DNA and rate of accumulation will depend on the rate of electrophoretic transport of DNA from the bulk solution leading to establishment of a steady flux. This experiment demonstrates that DNA could be effectively concentrated at the intersection in the presence of other biological contents (such as proteins) in 5 min by applying 9V on the device.

The electric field distribution at the intersection was simulated using commercial software (ComsolMultiphysics-V4.3) in order to understand the influence of various EK forces on the sample. The electrical boundary conditions set were as follows: The electrode in the sample channel was set at ground potential, and the other electrode in the accumulation channel was set at a positive potential. All the other channel surfaces were set to zero charge boundary condition because of the insulating property of the PDMS channel walls. The assumptions made were of charge conservation and uniform temperature. The electric field was simulated. Using the electric field and its distribution the electrophoretic force and DEP forces were calculated at the high field intersection region. The simulation was compared with the experimental results above to better understand the concentration mechanism.

Simulation shows that when a potential is applied (9V) the electric field established in the top sample channel is nearly 10 times that in the accumulation channel (FIG. 6(a)). Since the electrophoretic force transporting the DNA is proportional to the electric field, this geometry promotes transport of DNA in the sample channel towards the intersection region and a relatively weak transport or accumulation of the DNA in the accumulation channel. The simulation also shows that the electric field gradient reaches its maximum at the intersection edge, and drops significantly in other areas (FIG. 6(b)). FIG. 6c) illustrates the directions of the EP force (red arrows) and the DEP force (black arrows) acting on the constituents in blood. It shows that the EP force drives DNA into the gel at the intersection, while the DEP force drags DNA away from the gel. The magnitude of the forces is determined by the profile of the electric field, which further affects the accumulation of DNA.

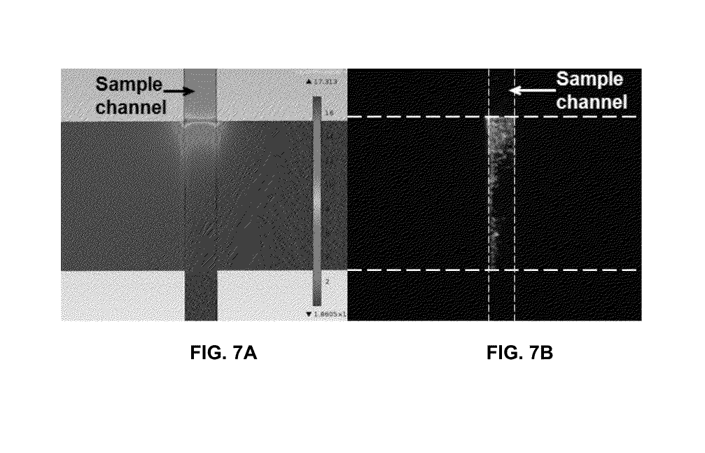

The experimental results obtained also show a similar accumulation profile as expected based on simulation (FIG. 7). The EP force reaches its maximum at the intersection edge, where the fluorescent intensity is the strongest. It indicates the DNA is accumulated mostly at the intersection edge due to the stronger EP force.

### Effect of Applied Voltage on DNA Accumulation

The voltages applied between the sample channel and accumulation channel determines the electric field strength and its distribution in the device, which directly affects the motion of DNA molecules. As analysed above, the dominant force for DNA molecules at the intersection is EP force. The electric field strength within the channel can be increased by increasing the voltage, which leads to larger EP forces on DNA. Therefore DNA molecules can be accumulated faster at the intersection at higher voltages reducing the time is required for DNA quantification.

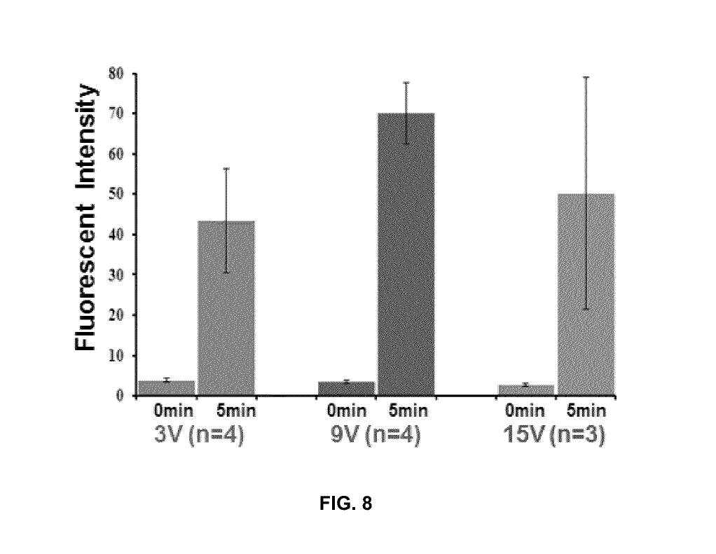

In total 3 different voltages (3V, 9V, and 15V) were applied for 5 min respectively using a ˜1.6 μg/ml DNA spiked plasma sample. The sample was prepared using the same method as in the last section. The results (FIG. 8) show that a small increase in the fluorescent intensity can be observed between 3V and 9V (p=0.0172, α=0.01) while the variation in the measurements decreased. Further increase in the potential to 15V caused the intensity to decrease (p=0.7355, α=0.01 between 3V and 15V; p=0.354, α=0.01 between 9V and 15V) along with a much larger variation in accumulation. Similar results were observed using 5 μg/ml DNA spiked plasma sample (data not shown).

According to the results above, the fluorescent intensity is the highest when a potential of 9V was applied throughout the accumulation process. However, based on simulation and the force calculation, the EP force should have been the strongest at 15 V.

This unexpected result is likely due to the excessive heat generated in the channels when a relatively high voltage (15V) is applied for 5 minutes. According to the numerical simulation results, the electric field strength at the intersection reaches around 20 kV/m when 9V was applied and over 30 kV/m when using 15V. The high electric field strength formed is comparable to that normally used in capillary electrophoresis (CE), in which Joule heating can yield radial temperature gradients [26]. However, no heat management strategies were applied in our device as those used in CE, thus temperature variations and ineffective heat dissipation in the channels can cause the mobility changes of the contents in the sample liquid [27]. This could potentially be the cause for reduction in accumulation at 15V.

Based on the results in this experiment, an optimal potential of 9V was used in subsequent experiments.

### Quantification of DNA Accumulation

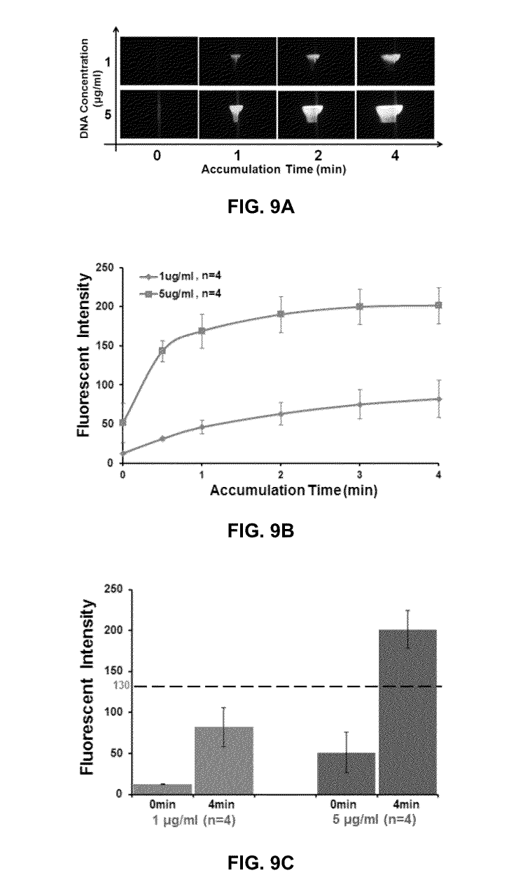

The rate of accumulation of DNA and the net amount accumulated over a certain period of time should be proportional to the initial concentration of the DNA present in the channel. To characterize it, and to demonstrate the feasibility of distinguishing between 1 μg/ml and 5 μg/ml DNA, a series of experiments with different concentrations of DNA in buffer sample was performed. Here λ-DNA was diluted in 1× TE buffer and mixed with PicoGreen dye to obtain two sample solutions with DNA concentrations of 5 μg/ml and 1 μg/ml, which were used to mimic the cfDNA level in survivors and non-survivors of severe sepsis patients respectively. This sample contains no proteins, cells or other contaminants. The electric potential was applied for 4 minutes, and the results are shown in FIG. 9.

FIG. 9(a) clearly shows that the fluorescent intensity of both samples (1 μg/ml and 5 μg/ml) increased with time. The shape of the DNA accumulation in the gel followed the distribution of the electric field as seen in the simulation. There was higher accumulation close to the top edge of the intersection region and some of the DNA migrated towards the anode with increasing time. The measurement of fluorescent intensity with time (FIG. 9(b)) also showed a clear difference between 1 μg/ml and 5 μg/ml samples. It indicates that the accumulation of DNA in a sample with concentration of 1 μg/ml was relatively linear and slow throughout the 4 minutes, while that of 5 μg/ml sample increased rapidly within the first 30 seconds followed by a slower increase and a plateau after 3 min. The plateau was formed due to the saturation of the fluorescent signals at the intersection. FIG. 9(c) shows that during the accumulation process, the fluorescent intensity of 1 μg/ml sample increased from average 12.4 to 82.0, while that of 5 μg/ml sample increased from average 51.3 to 201.4. Before applying an electric field, no significant difference between 1 μg/ml and 5 μg/ml sample could be observed (p=0.0527, α=0.01). But after 4 minutes DNA accumulation, the average fluorescent intensities were significantly different (p=3.7×10−4, α=0.01). The dash line indicated a threshold value of 130 could be set to distinguish the two concentrations.

### Interference of Proteins on DNA Quantification

It has been shown that 1 μg/ml and 5 μg/ml DNA in buffer samples can be rapidly distinguished using the device. But other constituents in blood plasma (mostly proteins) may affect the accumulation and quantification process. Therefore, DNA spiked plasma sample was prepared to simulate the blood plasma collected from ICU patients in hospital, and was used to investigate the interference of proteins on DNA quantification. This sample contains other biomolecules like proteins in the DNA accumulation process. The sample preparation method is similar as preparing the DNA in buffer sample, except that the DNA solution was added to human blood plasma instead of TE buffer.

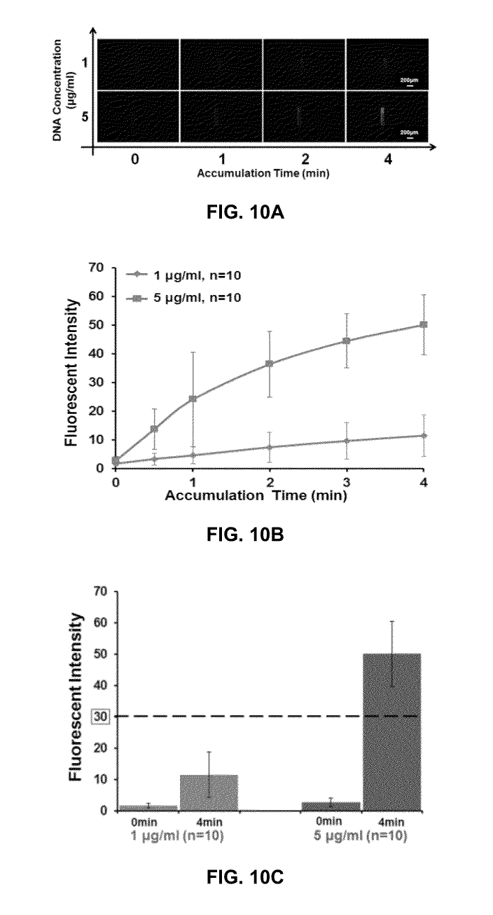

As shown in FIG. 10, the fluorescent signals of 5 μg/ml and 1 μg/ml samples both increased at the intersection. After the DNA accumulation in 4 minutes, the fluorescence of 5 μg/ml sample was much stronger than that of the 1 μg/ml sample. The fluorescent intensity of 1 μg/ml DNA showed a linear increase which was similar in trend as that of DNA in buffer sample but reduced in magnitude. The fluorescent signals of 5 μg/ml sample increased rapidly within the first minute followed by a smaller slope in the rest accumulation period. This trend is comparable with the fluorescence curve of 5 μg/ml DNA in buffer sample. The 1 μg/ml sample reflects an increase in fluorescent intensity from average 1.7 to 11.5 during the 4 minutes electrokinetic accumulation, while the 5 μg/ml sample demonstrates a faster increase from average 2.7 to 50.1. There was no significant difference (p=0.0444, α=0.01) between 1 μg/ml and 5 μg/ml samples before applying the electric field (0 min), but a highly significant difference (p=4.5×10⁻⁸, α=0.01) could be seen after applying 9V for 4 minutes on the device. A threshold value of 30 could be set to distinguish the samples.

Comparing the data between DNA in buffer samples and the DNA spiked plasma samples, at the end of DNA accumulation, the fluorescent intensity values of DNA in buffer samples are 82.0±24.0 (1 μg/ml) and 201.4±23.0 (5 μg/ml), while values of the DNA spiked plasma samples are 11.5±7.2 (0.8 μg/ml) and 50.1±10.4 (4.2 μg/ml). The values are clearly different between the two groups of samples even though the experimental setups are identical.

Two main features are worth noting in the results. One is that the variation of the fluorescent intensity of the DNA in buffer samples is larger than that of the DNA spiked plasma samples. The relative uncertainties of DNA in buffer samples are ˜29.3% (1 μg/ml) and ˜11.4% (5 μg/ml), which is smaller than the relative uncertainties of the DNA spiked plasma samples (˜62.6% for 1 μg/ml and ˜20.8% for 5 μg/ml). The other feature is that the average values of the fluorescent intensity of the DNA in buffer samples are significantly higher than that of the DNA spiked plasma samples.

There are 3 possible reasons for the results obtained: 1) DNA binds with plasma proteins. DNA in buffer can bind freely with PicoGreen molecules and can move freely between the solution and the gel under the influence of electric field. Thus the accumulation of DNA in the gel is repeatable and reflective of the concentration of the DNA in the sample. In the plasma sample, due to the presence of various plasma proteins, DNA-proteins complexes can be formed. For example, it has been shown that strong bindings can happen between human serum albumin (HSA) and DNA G-C bases and the backbone phosphate groups after mixing HSA and DNA solution [28]. These interactions between DNA and proteins can compete with DNA-PicoGreen binding, which potentially leads to a decreased fluorescence using the DNA spiked plasma sample. DNA-protein complexes may also have a different electrophoretic mobility, and could reduce the accumulation of DNA in the gel. 2) PicoGreen molecules interact with other constituents in plasma. PicoGreen molecules may have interactions with proteins or other contaminants as well. Therefore, less dye is available for PicoGreen-DNA binding. For example, a characterization study has shown that presence of proteins such as bovine serum albumin (BSA) can affect the intensity of the fluorescent signals of PicoGreen in a sample although the linearity of PicoGreen signal is not affected. It implies a similar change may probably occur in plasma samples. 3) The DNA-protein complex can be affected by an increased DEP force. The DNA-protein complex formed has a smaller charge-to-volume ratio than that of a single DNA molecule. Therefore, the DEP forces are more significant and could reduce the mobility of the DNA-protein complex towards the gel. Thus the net force driving DNA into the gel becomes smaller, which led to an impaired and less stable DNA accumulation process.

DNA Quantification using Clinical Blood Plasma

Clinical samples from severe septic patients were used to further validate the device performance and experimental setup. It was also used to investigate the interference of proteins in the samples. Here, plasma samples from 3 patients with different cfDNA levels (6 μg/ml, 10 μg/ml, and 20 μg/ml) that have been quantified by conventional DNA concentration and UV absorbance measurement were selected. Plasma from 3 healthy donors were also used but not pre-measured, thus the original cf-DNA concentrations remained unknown. The clinical plasma samples were processed by mixing with the 10-fold diluted PicoGreen reagent with a 10:1 volume ratio (plasma: PicoGreen). The samples were injected into the sample channel and 9V was applied for 5 minutes.

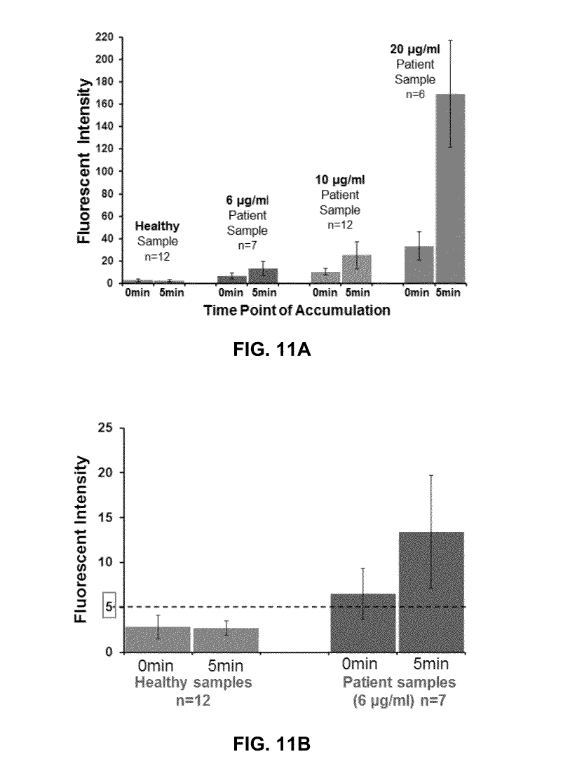

The results (FIG. 11) shows that after 5 minutes DNA accumulation with 9V applied across the channels, the average fluorescent intensity of the healthy samples did not increase. In the case of patient samples the intensity increased for all the concentrations (6 μg/ml: from 6.5 to 13.4; 10 μg/ml: from 10.6 to 25.1; and 20 μg/ml: from 33.4 to 169.3). There was no significant difference between the 6 μg/ml patient sample and the samples from healthy donors before applying the electric field (p=0.0126, α=0.01). But at the end of DNA accumulation, a highly significant difference could be detected between them (p=0.004, α=0.01). This result demonstrates that a more reliable distinction between the two samples can be obtained after applying the electric field. The patient samples with relatively high cfDNA concentrations (10 μg/ml and 20 μg/ml) were significantly different from the healthy donor samples, even before applying electric field (p=7.9×10⁻⁷ between healthy sample and 10 μg/ml sample; p=0.0019 between healthy sample and 20 μg/ml sample, α=0.01). After applying the electric field for 5 minutes, the distinctions remained highly significant (p=5.0×10⁻⁵ between healthy sample and 10 μg/ml sample; p=3.6×10⁻⁴ between healthy sample and 20 μg/ml sample, α=0.01). However, the fluorescent intensities between the 6 μg/ml and 10 μg/ml patient sample were not statistically different both in the beginning (p=0.0110, α=0.01) and at the end (p=0.0134, α=0.01) of DNA accumulation. These results have shown that healthy donor samples and the severe sepsis patient samples could be differentiated using our method.

The fluorescent intensity of the 6 μg/ml clinical plasma sample is much lower (13.4±6.3), compared with the 5 μg/ml DNA in buffer sample (201.4±23.0) and the 5 μg/ml DNA spiked plasma sample (50.1±10.4). The relative uncertainty of the 6 μg/ml clinical plasma (≈47.0%) is larger as well. This further shows that the interference of proteins and other interferences on the cfDNA accumulation and quantification. There are 2 other factors that may contribute to this result besides the reasons mentioned in the section of DNA spiked plasma sample. The first one is the individual variations of the clinical plasma samples. The clinical plasma samples used in this experiment were collected from different patients and healthy donors. Therefore, the samples may not be homogeneous and will have individual variations. The amount of protein and other constituents in plasma could possibly change with patients which could indirectly affect the DNA accumulation process. The second possibility is the interference of histone in the patient plasma samples. Increased histone levels have been found in samples from severe septic patients, due to possible apoptotic or necrotic cells. Histone is able to keep cfDNA tightly coiled, thus the binding between DNA and PicoGreen molecules can be significantly affected. Meanwhile, there are other non-histone proteins involved in sepsis process, which can potentially bind with DNA molecules in plasma from septic patients. These mechanisms can lead to less DNA-PicoGreen binding, which further lead to a decreased fluorescent intensity.

DNA Quantification using DNA Spiked Whole Blood

The ultimate goal of this device is to complete cfDNA quantification directly in whole blood sample, which can further simplify the sample preparation procedure and realize a true point-of-care testing. Before moving to the clinical whole blood sample, preliminary experiments were conducted using DNA spiked whole blood sample, which contains all the constituents in blood including blood cells and proteins. Here λ-DNA was mixed with whole blood from a healthy donor, followed by mixing it with 10-fold diluted PicoGreen reagent with a 1:1 volume ratio to obtain a final concentration of 5 μg/ml and 1 μg/ml DNA spiked in whole blood. A control sample was prepared by mixing 10-fold diluted PicoGreen and whole blood with no extraneous DNA added.

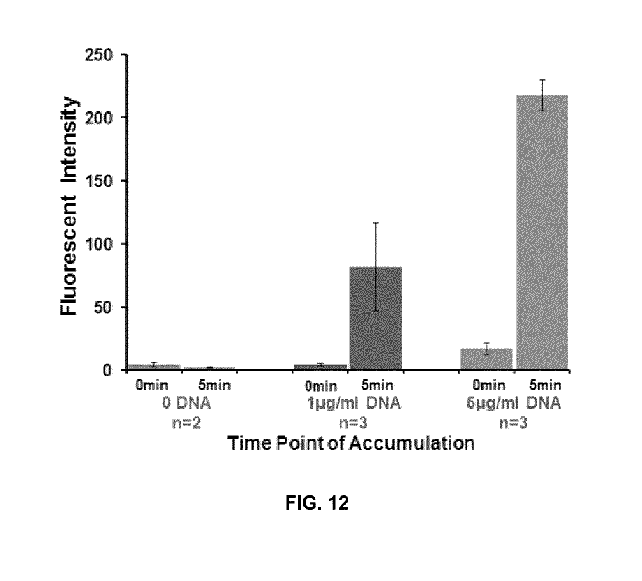

Accumulation of DNA from these samples in the device at a potential of 9V for 5 minutes showed that the 3 concentrations can be clearly separated after electrophoretic concentration (FIG. 12). The fluorescent intensity difference between the 0 μg/ml sample and the 1 μg/ml sample increases substantially after DNA accumulation (p=0.058, α=0.01) compared with before applying the electric field (p=0.9711, α=0.01); the difference between the 5 μg/ml sample and the 0 μg/ml sample is not significant before DNA accumulation (p=0.0278, α=0.01). However, the difference becomes significant (p=0.0010, α=0.01) after accumulation.

It can be seen that the p values are relatively large due to the small number of experiments conducted (n), especially for the 0 μg/ml sample (n=2). However, the data provides a demonstration that the whole blood of healthy donors, which has a similar cfDNA concentration as survivors, can be directly distinguished from the whole blood of non-survivors in severe sepsis patients.

### Immobilization of PicoGreen Reagents

Although the sample preparation process has been significantly simplified by using the device, current experiments still require pre-mixing of the fluorescent dye reagents and the sample liquid, which can complicate the point of care use of this device. To realize this goal, PicoGreen dye must be integrated with the device in advance.

PicoGreen reagent (50-fold diluted) from the kit was injected into the channels before gel filling and sample loading. The device was then wrapped with aluminium foil with a small opening to let the liquid evaporate. Upon leaving the device in a dark and ventilated environment for overnight, the solution in the channels was fully evaporated, leaving a residue of dried PicoGreen on the channel walls. These molecules could later be re-suspended upon loading of sample liquids, and intercalate with cfDNA molecules in the samples. After the gel filling, 5 μg/ml DNA spiked plasma sample was loaded into the sample channel without pre-mixing with PicoGreen, followed by applying 9V for 5 min. A control test was conducted by using a device that had no PicoGreen deposited, and the results were compared.

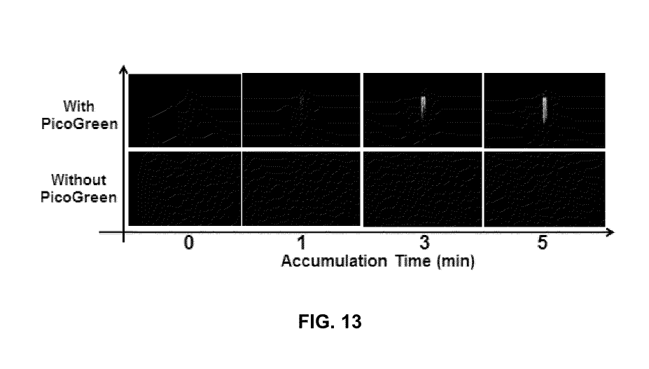

Based on FIG. 13, it was clear that with PicoGreen molecules pre-deposited in the channels, fluorescence could be detected and the accumulation of cfDNA was observed. In comparison, the device without PicoGreen shows no observable fluorescence during the whole process since there was no binding of DNA and the dye.

This experiment demonstrated the possibility of dye immobilization in the device, which could potentially simplify the sample preparation steps. The re-suspension of PicoGreen and its effect on device performance has to be carefully studied. The concentration of PicoGreen used, the distribution of the dried dye inside the microchannels and the process of drying must be optimized to ensure that sufficient sensitivity is obtained while still minimizing the cost of the reagents.

This Example presents a novel device enabling a simplified rapid DNA quantification method directly in blood plasma, which is potential to be used in whole blood samples as well. The device is low-cost (PDMS based), simple structured, has low power consumption (9V), requires a small sample volume (<10 μl), and can complete the quantification in 5 min. These characteristics make the device a good candidate for Point-of-care prognosis of sepsis condition. The experimental results show that clinical plasma from healthy donors (contains similar cfDNA levels as survivors of severe sepsis patients) are able to be distinguished from that of non-survivors of severe sepsis patients. Further studies are required to use this device for accurately quantifying samples with various cfDNA concentrations. The DNA accumulation process can be affected by proteins and cells in blood, but the linearity of the signals was found to suitable.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

All publications, patents and patent applications are herein incorporated by reference in their entirety to the same extent as if each individual publication, patent or patent application was specifically and individually indicated to be incorporated by reference in its entirety.

### REFERENCES

1. Bone R C, Balk R A, Cerra F B, Dellinger R P, Fein A M, Knaus W A, Schein R M, and Sibbald W J, Chest., 1992, 101, 1644;
2. Strand K, and Flaatten H, Acta Anaesthesiol Scand., 2008, 52, 467;
3. Dwivedi D J, Toltl L J, Swystun L L, Pogue J, Liaw K L, Weitz J I, Cook D J, Fox-Robichaud A E, Crit Care, 2012, 16, R151;
4. Pierrakos C, and Vincent J L, Crit Care., 2010, 14, R15;
5. Rhodes A, Wort S J, Thomas H, Collinson P, and Bennett E D, Crit Care, 2006, 10, R60;
6. Terence Chan, and Frank Gu, Expert Rev Mol Diagn., 2011, 11, 487.
7. Somanath Bhat, Natalie Curach, Thomas Mostyn, Gursharan Singh Bains, Kate R. Griffiths, Anal. Chem., 2010, 82, 7185;
8. K. Nielsen, H. S. Mogensen, B. Eriksen, J. Hedman, W. Parson, and N. Morling, International Congress Series, 2006, 1288, 759;
9. Pak Kin Wong, Che-Yang Chen, Tza-Huei Wang, and Chih-Ming Ho, Anal. Chem., 2004, 76, 6908;
10. Jung-Rong Du, and Hsien-Hung Wei, Biomicrofluidics, 2010, 4, 034108;
11. N. G. Green, A. Ramos, A. González, H. Morgan, and A. Castellanos, Phys Rev E., 2000, 61, 4011;
12. D. Kalyanasundaram, J.-H. Kim, W.-H. Yeo, K. Oh, K.-H. Lee, M.-H. Kim, S.-M. Ryew, S.-G. Ahn, D. Gao, G. A. Cangelosi, J.-H. Chung, Anal Bioanal Chem, 2013, 405, 1977;
13. Faisal A. Shaikh and Victor M. Ugaz, PNAS, 2006, 103, 4825;
14. Ho Suk Lee, Wai Keung Chu, Kun Zhang, and Xiaohua Huang, Lab Chip, 2013, 13, 3389;
15. Rahul Dhopeshwarkar, Li Sun, and Richard M. Crooks, Lab Chip, 2005, 5, 1148;
16. Jian Wen, Lindsay A. Legendre, Joan M. Bienvenue, and James P. Landers, Anal. Chem., 2008, 80, 6472;
17. Michael C. Breadmore, Kelley A. Wolfe, Imee G. Arcibal, Wayne K. Leung, Dana Dickson, Braden C. Giordano, Mary E. Power, Jerome P. Ferrance, Sanford H. Feldman, Pamela M. Norris, and James P. Landers, Anal. Chem., 2003, 75, 1880;
18. Thomas Rohr, Emily F. Hilder, John J. Donovan, Frantisek Svec, and Jean M. J. Fréchet, Macromolecules, 2003, 36, 1677;
19. Takahito Nakagawaa, Tsuyoshi Tanakaa, Daisuke Niwab, Tetsuya Osakab, Haruko Takeyamaa, Tadashi Matsunaga, Journal of Biotechnology, 2005, 116, 105;
20. Weidong Cao, Christopher J. Easley, Jerome P. Ferrance, and James P. Landers, Anal. Chem., 2006, 78, 7222;
21. Jungkyu Kimand Bruce K. Gale, Lab Chip, 2008, 8, 1516;
22. Hiroyuki Ota, Tae-Kyu Lim, Tsuyoshi Tanaka, Tomoko Yoshino, Manabu Harada, and Tadashi Matsunaga, Journal of Biotechnology, 2006, 125, 361;
23. Marc Karlel, Junichi Miwa, Gunter Roth, Roland Zengerle, and Felix von Stetten, IEEE 22nd International Conference on Micro Electro Mechanical Systems, 2009, 276;
24. David Erickson, Encyclopedia of Microfluidics and Nanofluidics, 2014, 1;
25. Walter Schrott, Zden\check{e}k Slouka, Petr \check{C}ervenka, Ji\check{r}i Ston, Marek Nebyla, Michal P\check{r}ibyl, and Dalimil\check{S} nita, Biomicrofluidics, 2009, 3, 044101;
26. Xiangchun Xuan, Guoqing Hu, and Dongqing Li, Electrophoresis, 2006, 27, 3171;
27. Beckman Coulter Inc., Introduction to Capillary Electrophoresis, Handbook. [Online]http://sciex.com/Documents/manuals/IntroductiontoCapillaryElectrophoresisVol-I.pdf
28. H. Malonga, J. F. Neault, H. Arakawa, and H. A. Tajmir-Riahi, DNA AND CELL BIOLOGY, 2006, 25, 63;
29. Van der Vaart Pretorius P J (2008) Circulating DNA. Its Origin and Fluctuation. Ann N Y Acad Sci 1137: 18-26.
30. Schwarzenbach H, Hoon D S, Pantel K (2011) Cell-free nucleic acids as biomarkers in cancer patients. Nat Rev Cancer 11 (6) 426-437;
31. Rainer, T. H. et al. 2006. Plasma [beta]-globin DNA as a prognostic marker in chest pain patients, Clin. Chim. Acta 368: 110-113.
32. Rhodes, A. et al. 2006. Plasma DNA concentrationas a predictor of mortality and sepsis in critically ill patients. Crit. Care 10: R60.
33. Fatouros, I. G. et al. 2006. Cell-free plasma DNA as a novel marker of aseptic inflammation severity related to exercise overtraining. Clin. Chem. 52: 1820-1824.

1. A microfluidic device for the quantification of nucleic acids in a sample, the device comprising:
a sample channel;
an accumulation channel that forms an intersectional area with a portion of the sample channel;
a first electrode positioned within the sample channel and a second electrode positioned with the accumulation channel for applying an electric potential across the intersectional area so that when an electric potential is applied nucleic acids in the sample channel are forced into the accumulation channel across the intersectional area.

2. The microfluidic device of claim 1, wherein the sample channel and accumulation channel are in fluid communication over the intersectional area.

3. The microfluidic device of claim 1, wherein the sample channel and the accumulation channel are made of a polymeric organosilicon compound, glass, polystyrene, polycarbonate, epoxy, cyclic olefin polymer or acrylic.

4. The microfluidic device of claim 1, wherein the sample channel comprises a sample inlet and a sample outlet and the intersectional area is positioned between the sample inlet and the sample outlet and the accumulation channel comprises an accumulation channel inlet and an accumulation sample outlet and the intersectional area is positioned between the accumulation channel inlet and the accumulation channel outlet.

5. The microfluidic device of claim 1, wherein the accumulation channel contains a medium of lower electrophoretic mobility than the sample channel.

6. The microfluidic device of claim 5, wherein the medium of lower electrophoretic mobility is a gel.

7. The microfluidic device of claim 1, wherein the sample channel and/or accumulation channel contains a fluorescent tag that binds nucleic acids.

8. The microfluidic device of claim 1, further comprising a power supply for providing an electric potential to the first electrode and second electrode.

9. The microfluidic device of claim 8, wherein the power supply is a direct current (DC) power supply that provides an electric potential of between about 3 volts and 15 volts.

10. The microfluidic device of claim 1, wherein the sample comprises blood cells and when an electric potential is applied the blood cells are forced away from the intersectional area in the sample channel by a dieletrophoretic force.

11. The microfluidic device of claim 1, further comprising a sensor for detecting fluorescence in the intersectional area.

12. A method for quantifying cell free DNA (cfDNA) in a sample, the method comprising:
introducing the sample into the sample channel of the microfluidic device of claim 1;
applying an electric potential across the intersectional area;
detecting a level of fluorescence in the intersectional area, wherein the level of fluorescence in the intersectional area is indicative of the amount of cfDNA in the sample.

13. The method of claim 12, wherein the sample is contacted with a fluorescent tag that binds to nucleic acids prior to introducing the sample into the sample channel or wherein the accumulation channel and/or sample channel contains an electrophoretic medium that comprises a fluorescent tag that binds to nucleic acids.

14. The method of claim 12, wherein applying an electric potential across the intersectional area comprises applying a voltage of between about between about 3 volts and 15 volts and the electric potential is applied across the intersectional area for less than 10 minutes.

15. The method of claim 12, wherein the sample is blood or blood plasma.

16. The method of claim 12, further comprising comparing the level of fluorescence in the intersectional area to a control level.

17. The method of claim 16, wherein the sample is from a subject having or suspected of having sepsis, and
(a) the control level is representative of subjects with severe sepsis and a similarity between the level of fluorescence in the intersectional area of the sample from the subject and the control level is indicative of the subject having or developing severe sepsis, or
(b) the control level is representative of subjects without severe sepsis and an increase in the level of fluorescence in the intersectional area of the sample from the subject relative to the control level is indicative of the subject having or developing severe sepsis.

18. The method of claim 17, wherein the control level representative of subjects having or developing severe sepsis corresponds to a blood cfDNA level of greater than 3.5 μg/ml and the control level representative of subjects without severe sepsis corresponds to a blood cfDNA less than 1.5 μg/ml.

19. A method for concentrating and quantifying cell free DNA (cfDNA) in a sample, the method comprising:
introducing the sample into a sample channel;
applying an electric potential across an intersectional area separating the sample channel from an accumulation channel to generate an electrophoretic force acting on the cfDNA in the sample channel so that the cfDNA in the sample channel is attracted to the intersectional area; and
detecting cfDNA in the intersectional area.

20. The method of claim 19, wherein the sample is contacted a fluorescent tag that binds to nucleic acids and detecting cfDNA in the intersectional area comprises detecting a level of fluorescence in the intersectional area, wherein the level of fluorescence in the intersectional area is indicative of the amount of cfDNA in the sample.
